(19) United States
(12) Patent Application Publication
(10) Pub. No.: US 2021/0105975 A1
(43) Pub. Date: Apr. 15, 2021

(54) ANIMAL COLLAR AND TIGHTENING SYSTEM AND METHOD FOR USING SAID SYSTEM

(71) Applicant: Yusuf Yehia Amr, Lynnwood, WA (US)

(72) Inventor: Yusuf Yehia Amr, Lynnwood, WA (US)

(21) Appl. No.: 16/600,944

(22) Filed: Oct. 14, 2019

(51) Int. Cl. A01K 27/00; A01K 15/02

(52) U.S. Cl. CPC A01K 27/001; A01K 15/02

(57) ABSTRACT

The present invention based around the idea of making or modifying a tightening system, can be incorporated into a variety of animal collars and leashes and must include at least two tensioning mechanisms, allowing the operator to fine tune the amount of tension a collar applies around an animal's neck. This invention includes the system and any collars that incorporate the system into their design. It helps create a newer, safer, more comfortable, and more reliable alternative to existing collars, which don't have two or more tensioning mechanism, and therefore can't independently change the tension/size of a collar. Existing collars more often than not are difficult to fit, and can be too tight, which is dangerous to the dog, or too loose, which is dangerous to the dog as well as any other animals/people in the area. The present invention solves these issues.

### BACKGROUND OF THE INVENTION

The present invention is in the field of animal collars and accessories.

### DESCRIPTION OF RELATED ART

Getting the right fit on a collar can be hard to achieve, especially when applying or fitting a martingale, prong, pinch collar, choke, or slip collar to an animal's neck. The inability to adjust the size/tension of the collar in small enough increments often times forces people to regularly use collars that are either a little too tight/small or a little too loose/large for their animals. This poses a safety threat to the animal and/or to the public.

Collars that are too small or too tight can cause injury or discomfort to an animal. Additionally, since many animals' necks expand when they exert energy or exercise, and since most collars don't expand and contract with an animal's neck, then this is another reason that a collar that is too small/tight poses a risk.

Collars that are too large or loose tend to either slide off an animal's neck/head too easily, or slide down to the base of an animal's neck, which increases likelihood of injury to the animal's trachea. Loose collars also aren't ideal for giving functional corrections while training. Not only will the correction fail to transmit through a leash and collar properly, but a loose collar may even come apart or come undone in the midst of a correction. This is a big issue because timing is everything when it comes to animal training, and during a correction is one of the worst and sometimes most dangerous times for gear to fail.

Therefore, what is clearly needed is a new, safer, and more reliable style of collar, that can be adjusted in small increments in order to solve or avoid the problems mentioned above.

### BRIEF SUMMARY OF INVENTION

In one embodiment of the invention, a tightening system/apparatus which can be used in the making, manufacture, or modification of a collars and leashes, is provided comprising at least one primary tensioning mechanism, and at least one supplemental tensioning mechanism.

Also in one embodiment the tightening system is modular and can be broken down into separate components to make different standalone accessories. Also in one embodiment a primary tensioning mechanism comprises a flexible, semi rigid material or a flexible material with poor elastic properties. Also in one embodiment a supplemental tensioning mechanism comprises a flexible, semi rigid material or a flexible material with good elastic properties. Also in one embodiment an object to which a leash clips is a component of the tightening system. Also in one embodiment a collar tightness restrictor is included. Also in one embodiment a release mechanism is included. Also in one embodiment an adjustment mechanism is included. Also in one embodiment, training collar parts, such as prongs or triangular links, are included.

In another embodiment of the invention an animal collar that incorporates/utilizes a tightening system/apparatus that has two or more tensioning mechanisms, is provided comprising a main collar body.

Also in one embodiment a main collar body comprises one collar body. Also in one embodiment a main collar body comprises more than one collar body built into one collar body. Also in one embodiment a main collar body comprises a combination of a collar bodies or components taken from other collars. Also in one embodiment, a main collar body comprises an object to which a leash clips. Also in one embodiment a main collar body or additional collar body can comprise a variety of different materials. Also in one embodiment a main collar body comprises a release mechanism.

In another aspect of the invention a method of putting a collar on or taking a collar off an animal comprises the steps (a) put a collar comprising at least two tensioning mechanism around an animal's neck, (b) tighten at least one of the supplemental tensioning mechanism(s) in order to fine tune the tension on the collar until said collar reaches a desired fit, (c) apply leash pressure to control an animal or give corrections.

In one embodiment of the method, a collar is wrapped around an animal's neck. In another embodiment of the method, a collar is slipped over an animal's head and placed on the animal's neck.

### BRIEF DESCRIPTION OF DRAWINGS

FIG. 1 is a plan view that illustrates an embodiment of a collar made using an embodiment of a tightening system/apparatus, which enables an operator to control the amount of tension a collar exerts on an animal's neck via the unique use of two or more tensioning mechanisms. It depicts a prong collar embodiment, and also can serve as a visual aid to a tightening sequence, which shows how the collar operates (in progressive steps to be read from left to right).

FIG. 2 is perspective view of an alternate embodiment of the invention presented in FIG. 1. It depicts a slip collar embodiment, as well as a new embodiment of a tightening system/apparatus, which can also be seen in FIG. 8. FIG. 2 also serves as visual aid to a tightening sequence, which shows how the collar operates (in progressive steps to be read from left to right).

FIG. 3 is a plan view of an alternate embodiment of a collar similar to the embodiment introduced in FIG. 1. This new embodiment, shows the same tightening system/apparatus embodiment, but includes a release mechanism on the main collar body and is a flat style collar instead of a prong collar.

FIG. 4 Is a plan view of one embodiment of a collar made using specific concepts illustrated in FIG. 1 and FIG. 3, it shares a very similar tightening system/apparatus, except for the fact that this embodiment of a tightening system utilizes a release mechanism which is located on the primary tensioning mechanism, behind the animal's head. Additionally, in this embodiment the supplemental tensioning mechanism isn't attached to an object to which a leash clips.

FIG. 5 Is a view of one embodiment of a collar made using specific concepts illustrated in FIG. 1, FIG. 3, and FIG. 4. This embodiment includes a release mechanism on the primary tensioning mechanism, in between the collar main collar body and an object to which a leash clips.

FIG. 6 is a plan view of one embodiment of a collar made to incorporate a different kind of training collar into its design (triangular or conical links or inserts). This embodiment also shows a release mechanism that joins a primary tensioning mechanism and an object to which a leash clips.

FIG. 7 is a perspective view of one embodiment of a collar made to incorporate a different kind of training collar (prong collar) into its design.

FIG. 8 Is a perspective view of two embodiments of a collar made an embodiment of the tightening system/apparatus, which can also be seen in FIG. 2. One embodiment of the collar is a slip lead variation and the other embodiment is a slip collar variation

FIG. 9. is a plan view of one embodiment of a standalone tightening system/apparatus, that utilizes the specific concepts surrounding the tightening system/apparatus illustrated in FIG. 7.

FIG. 10. is a plan view of several embodiments of a standalone supplemental tensioning assembly comprising a supplemental tensioning mechanism and an adjuster mechanism, which are key features in all the embodiments illustrated in FIG. 1, FIG. 2, FIG. 3, FIG. 4, FIG. 5, FIG. 6, FIG. 7, FIG. 8, and FIG. 9.

### DETAILED DESCRIPTION OF THE INVENTION

FIG. 1 is a plan view that illustrates an embodiment of a collar which is made to incorporate an embodiment of a tightening system/apparatus into its design. Said tightening system/apparatus enables an operator to control the amount of tension a collar exerts on an animal's neck via the unique use of two or more tensioning mechanisms. The first tensioning mechanism is always stronger than any supplemental tensioning mechanism(s) in any given embodiment, and is referred to as a primary tensioning mechanism. Any additional tensioning mechanisms are referred to as supplemental tensioning mechanisms. A first supplemental tensioning mechanism, is technically the second tensioning mechanism in any given embodiment, with the primary tensioning mechanism being the first. A second supplemental tensioning mechanism, is the third tensioning mechanism in any given embodiment, and so on. If an embodiment has two overall tensioning mechanisms, then it has one primary tensioning mechanism as well as a first supplemental tensioning mechanism, in which case the first supplemental tensioning mechanism may be referred to as a supplemental or the supplemental tensioning mechanism. The present embodiment consists of corrective prongs 106, a main collar body 105, a primary tensioning mechanism 101, a supplemental tensioning mechanism 102, an adjustment mechanism 103, and (depending on model) may include at least one release mechanism 104, which can be strategically placed in various convenient locations to decrease the time it takes for someone to put a collar on or take a collar off an animal. To increase or decrease the amount of tension the collar puts around an animal's neck, the operator should either position the adjustment mechanism 103 in a tightened or loosened position 102. The process of using two or more tensioning mechanisms instead of one when producing a collar is a truly innovative idea, never seen before by the market/industry, and is essential to the proper function of the various embodiments depicted throughout this patent. FIG. 1 also shows a sequence which should be viewed from left to right. The illustration on the left shows the invention before the adjustment mechanism 103 is tightened. The center illustration shows the invention after the adjustment mechanism 103 is moved to a tightened position by sliding it down the supplemental tensioning mechanism 102. Once the adjustment mechanism 103 is in a tightened position, the collar will stay securely in place on the animal. The third and final picture in sequence in FIG. 1 illustrates that a collar's regular corrective functions, which are normally performed using the primary tensioning mechanism, will still be 100% functional while using such a system. If leash pressure were applied to an object to which a leash clips 107 or to the primary tensioning mechanism 101 while the collar's adjustment mechanism 103 is in a tightened position, the collar would still get tighter. However, once leash pressure is released the collar will not loosen all the way. Rather, it will only loosen to the tension being held by the supplemental tensioning mechanism 102, which in this embodiment is made of a material that is flexible or has good elastic properties to ensure the collar will remain set at a comfortable tension and won't get too loose nor too tight. The more leash pressure that is applied, the tighter/smaller the collars becomes. The length of the main collar body 105 and size of the collar tightness restrictor 108 determines how small a given collar can get. The collar tightness restrictor 108 can help keep things looking much neater and will also limit how tight the collar gets by just a little bit.

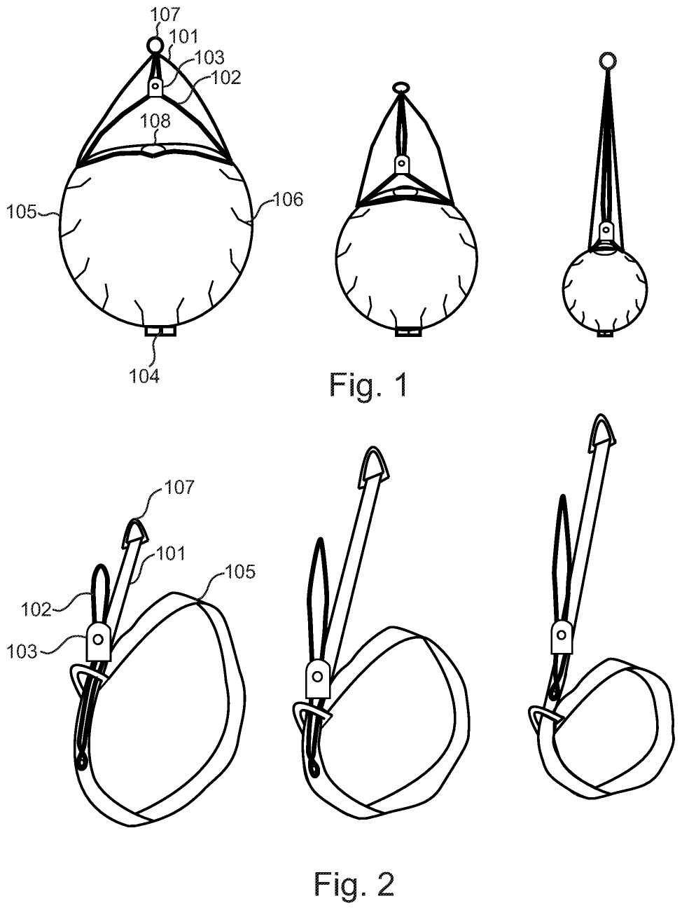

FIG. 2 is perspective view of an alternate embodiment of the invention presented in FIG. 1, and just like the embodiment in FIG. 1, the current embodiment also consists of a main collar body 105, a primary tensioning mechanism 101, a supplemental tensioning mechanism 102, an adjustment mechanism 103, and an object to which a leash clips 107. This embodiment is proof of the broad scope and breadth of the invention. There are many more embodiments and different styles that fit into the same scope, spirit, and breadth of this specific, yet highly applicable invention. FIG. 2 also shows the same type of left to right sequence as seen in FIG. 1. The main difference between this embodiment of this invention and the embodiment in FIG. 1 is that the current embodiment is known as a slip collar and incorporates a slip style tightening system, while the embodiment in FIG. 1 is known as a prong collar and incorporates a martingale style tightening system, yet the same general principles apply to both. Both consist of a main collar body 105, a primary tensioning mechanism 101, a supplemental tensioning mechanism 102, an adjustment mechanism 103, and an object to which a leash clips 107. They share many similarities in how they work too. Just like in FIG. 1, the sequence in FIG. 2 should be viewed from left to right. The illustration on the left shows the invention before the adjustment mechanism 103 is tightened. The center illustration shows the invention after the adjustment mechanism 103 is moved to a tightened position by sliding it down the supplemental tensioning mechanism 102. Once an adjustment mechanism 103 is in a tightened position, a collar will stay securely in place on the animal. the third and final picture in the FIG. 2 sequence illustrates that a collar's regular corrective functions will still be fully functional while using such a system. If leash pressure were applied to the object to which a leash clips 107 or to the primary tensioning mechanism 101 while the collar's adjustment mechanism 103 is in a tightened position, the collar would still get tighter. However, once leash pressure is released the collar will not loosen all the way. Rather, it will only loosen to the tension being held by the supplemental tensioning mechanism 102, which in this embodiment is made of a material that is flexible or has good elastic properties to ensure the collar exerts a comfortable amount of tension and doesn't get too loose nor too tight. The more leash pressure that is applied, the tighter/smaller the collars becomes. The length of the main collar body 105 determines how big a given collar can get.

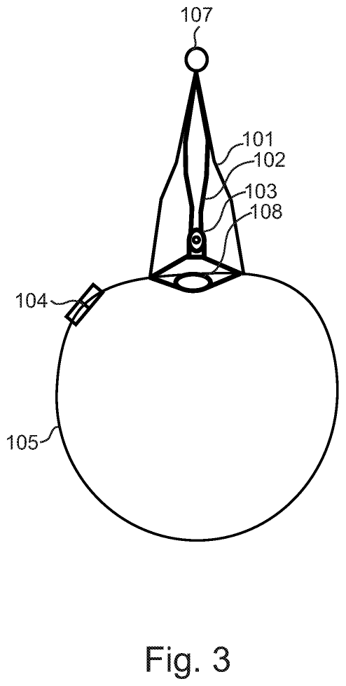

FIG. 3 is a plan view of an alternate embodiment of the current invention. This embodiment of a collar also utilizes a tightening system/apparatus which comprises a primary tensioning mechanism 101, a supplemental tensioning mechanism 102, an adjustment mechanism 103, an object to which a leash clips 107, and a release mechanism 104 that is strategically used to separate or connect 2 parts of a collar together. To tighten or loosen this embodiment the same applies as before. The operator simply positions the adjustment mechanism 103 in a tightened or loosened position 102. Once an adjustment mechanism 103 is in a tightened position, the collar will stay securely in place and will be less likely to come apart when issuing a correction. Additionally, the collar's regular corrective functions will still be fully functional while using such a system.

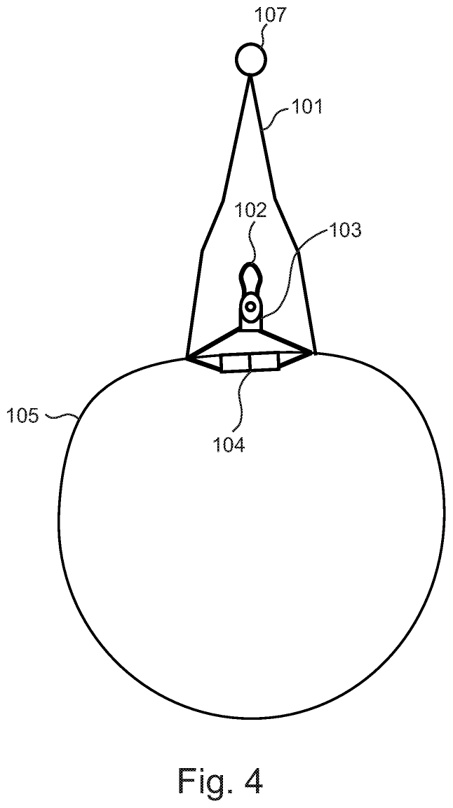

FIG. 4 Is a plan view of an alternate embodiment of a collar. This embodiment has a main collar body 105 and utilizes a primary tensioning mechanism 101, a supplemental tensioning mechanism 102, an adjustment mechanism 103, and a quick release mechanism 104, which can be strategically placed on the primary tensioning mechanism 101 and in between where the two ends of the collar tighten closer together behind the animal's neck/head. In this embodiment, the supplemental tensioning mechanism 102 does not extend all the way or connect to where the object to which a leash clips 107. This is not a requirement, but yet remains an open possibility for any embodiment that falls within the scope, spirit, and breadth of the current concept/invention. As before, this embodiment of the invention works similarly to all the other embodiments mentioned thus far. It's an embodiment of a specific invention with immense scope and breadth. The adjustment mechanism 103 is tightened to a tightened position by sliding it down the supplemental tensioning mechanism 102. Once an adjustment mechanism 103 is in a tightened position, a collar will stay securely in place and will be less likely to come apart when issuing a correction. Additionally, the collar's regular corrective functions will still be fully functional while using such a system.

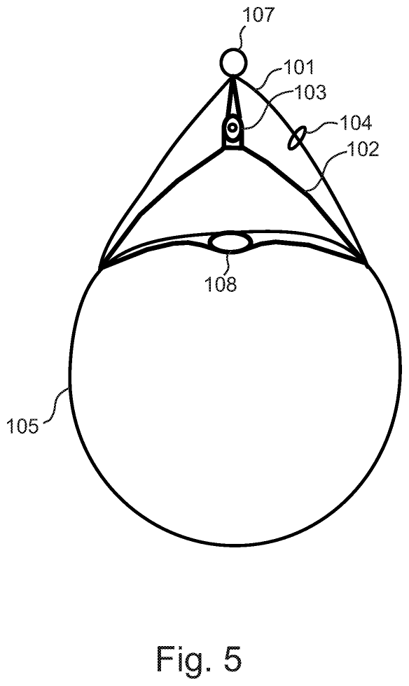

FIG. 5 Is a plan view of an alternate embodiment of a collar. This embodiment has a main collar body 105, and utilizes a primary tensioning mechanism 101, a supplemental tensioning mechanism 102, an adjustment mechanism 103, and a quick release mechanism 104, which is strategically located on the primary tensioning mechanism 101 in between the main collar body 105 and the object to which a leash clips 107. To increase or decrease the amount of tension the collar exerts around an animal's neck, the operator applies the same method that's used in FIG. 1, FIG. 2, FIG. 3, and FIG. 4. The operator positions the adjustment mechanism 103 in a tightened or loosened position 102 as previously described.

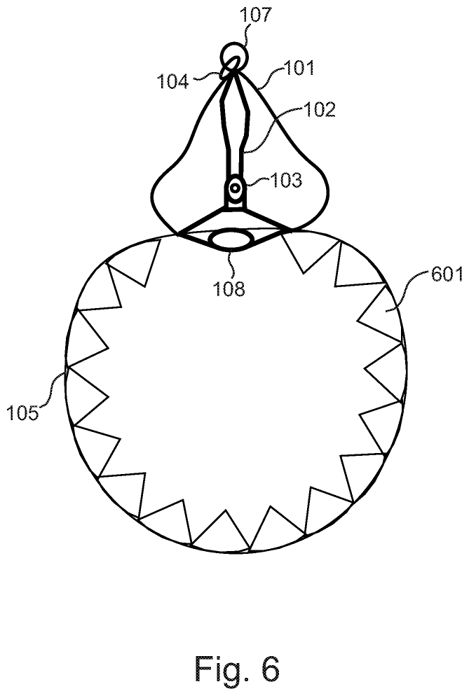

FIG. 6 is a plan view of another alternate embodiment of the invention. This embodiment utilizes a primary tensioning mechanism 101, a supplemental tensioning mechanism 102, an adjustment mechanism 103, and quick release mechanism 104 that connects the primary tensioning mechanism to any material or object in the vicinity of an object to which a leash clips 107. FIG. 6 also shows that in this embodiment, another style of training collar with triangular links 601 is incorporated into the main collar body 105. In alternate embodiments, any training collar or any training collar parts, may be incorporated to the invention. The tightening mechanism works as previously described. To increase or decrease the amount of tension a collar exerts around an animal's neck, the operator applies the same method that's used in FIG. 1, FIG. 2, FIG. 3, FIG. 4, and FIG. 5. The operator simply needs to position the adjustment mechanism 103 in a tightened or loosened position 102 as previously described.

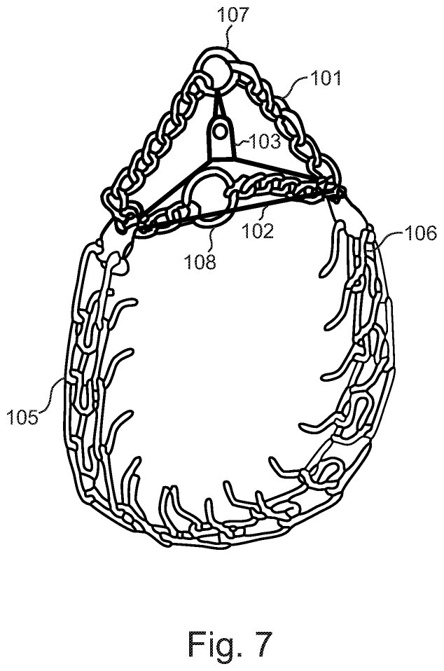

FIG. 7. is a perspective view of one embodiment of a collar. In this embodiment, a pinch or prong 106 collar is incorporated into the main collar body 105. This embodiment utilizes a primary tensioning mechanism 101 & a supplemental tensioning mechanism 102 as well as an adjustment mechanism 103. It works just like the previous embodiments. To increase or decrease the amount of tension the collar exerts around an animal's neck, the operator applies the same method that's used in FIG. 1, FIG. 2, FIG. 3, FIG. 4, FIG. 5 and FIG. 6. The operator positions the adjustment mechanism 103 in a tightened or loosened position 102 as previously described. As demonstrated previously, any embodiment of a collar that has a variable circumference (once fully assembled) may be adapted to the scope, spirit, and breadth of this invention.

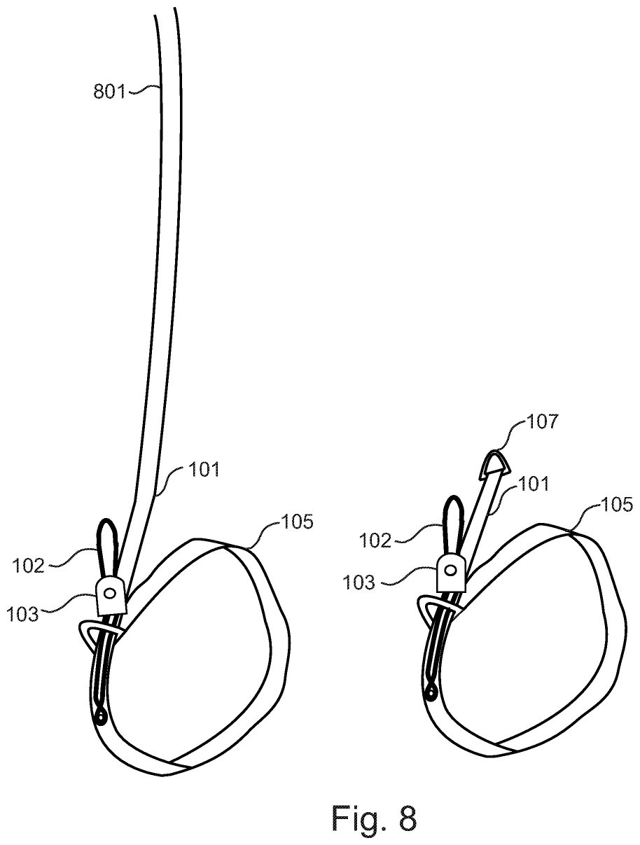

FIG. 8 Is a perspective view of two embodiment of a collar made using a different embodiment of the tightening system/apparatus used in FIG. 1, FIG. 3, FIG. 4, FIG. 5, FIG. 6, and FIG. 8. One collar embodiment is a slip lead variation with a leash component 801 to it and the other is a slip collar variation with an object to which a leash clips 107. Both feature a main collar body 105, and utilize a primary tensioning mechanism 101, a supplemental tensioning mechanism 102 as well as an adjustment mechanism 103. This is just one other embodiment of the broader concept and it functions the same way. To increase or decrease the amount of tension the collar exerts around an animal's neck, the operator applies the same method that's used in FIG. 1, FIG. 2, FIG. 3, FIG. 4, FIG. 5, FIG. 6, and FIG. 8, and positions the adjustment mechanism 103 in a tightened or loosened position 102 as previously described.

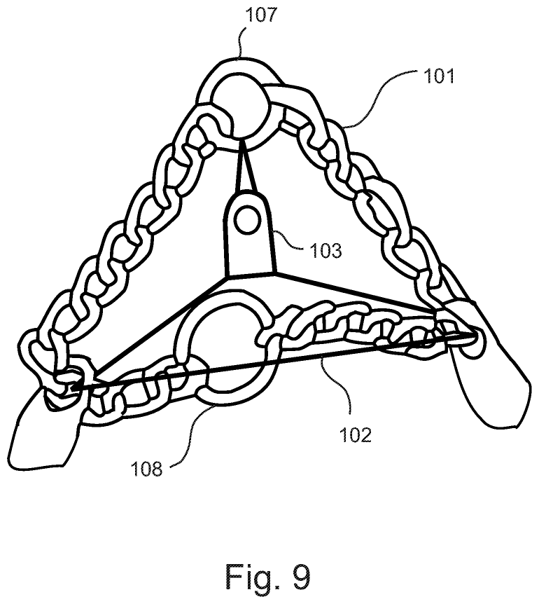

FIG. 9 is plan view of an embodiment of a tightening system/apparatus, which comprises a primary tensioning mechanism 101, a supplemental tensioning mechanism 102, an adjuster mechanism 103, a collar tightness restrictor 108, and an object to which a leash clips 107 to form a standalone/add on product, which is a key component in the embodiments illustrated in FIG. 1, FIG. 3, FIG. 4, FIG. 5, FIG. 6, FIG. 7, and FIG. 9. There are other similar systems/mechanisms/embodiments known to the inventor. This embodiment shares the same tightening features presented in the embodiments in FIG. 1, FIG. 2, FIG. 3, FIG. 4, FIG. 5, FIG. 6, and FIG. 7. To increase or decrease the amount of tension a collar exerts around an animal's neck, an operator simply positions an adjustment mechanism 103 in a tightened or loosened position 102 as previously described. A great example of an embodiment that's quite different, but still relies on the same concept is the tightening system/apparatus used in slip lead/slip collar, which are illustrated in FIG. 2 and FIG. 8.

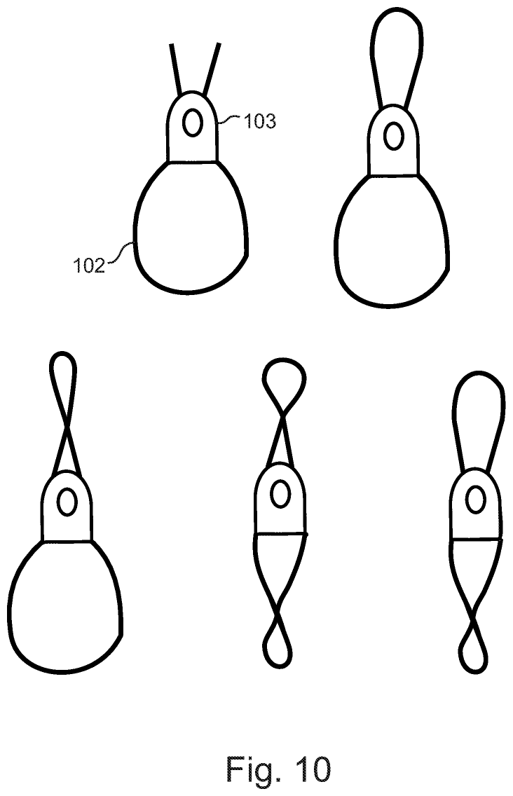

FIG. 10 is a plan view of several embodiments of part of a tightening system assembly, comprising of a supplemental tensioning mechanism 102 and an adjuster mechanism 103, to form a standalone/add on product, which is a key component in all the embodiments illustrated in FIG. 1, FIG. 2, FIG. 3, FIG. 4, FIG. 5, FIG. 6, FIG. 7, FIG. 8, FIG. 9, and throughout this patent. It depicts several different embodiments of a standalone supplemental tensioning mechanism 102, which in this case is paired with one adjustment mechanism 103. In these embodiments, the supplemental tensioning mechanism 102 which can be constructed of almost any flexible material, is made of a material with good elastic properties. However, there are many other materials with different properties known to the inventor. When paired with an aftermarket martingale or slip style lead or collar, these embodiments change how the aftermarket product functions. After some modification to said aftermarket collar, the operator will be able to position the adjustment mechanism 103 in a tightened or loosened positions 102 to tighten or loosen these embodiments using the same fundamental principles applied throughout this invention.

1. A tightening system/apparatus which can be used in the making, manufacture, or modification of a collar or collars, wherein said tightening system/apparatus comprises
at least two tensioning mechanisms.

2. An animal collar, which incorporates into its design a tightening system/apparatus that has at least two tensioning mechanisms and comprises
a main collar body.

3. A method of putting a collar on or taking a collar off an animal, used to achieve a desired fit, that can be applied to a variety of animal collar styles or leash styles, wherein
an operator puts said collar comprising at least two tensioning mechanism around an animal's neck;
then tightens one or more supplemental tensioning mechanism in order to fine tune the tension on said collar until said collar reaches a desired fit.

4. The tightening system in claim 1, comprises
a modular design and can be broken down into separate components or a standalone accessories.

5. The tightening system in claim 1, comprises
a primary tensioning mechanism and at least one supplemental tensioning mechanism.

6. The primary tensioning mechanism in claim 5, comprises
a flexible, semi rigid material or a flexible material with high tensile strength such as but not limited to, chain, rope, cord, leather, plastic, synthetic materials, webbing, and/or rubber, or any semi rigid, flexible, or fibrous material.

7. The supplemental tensioning mechanism(s) in claim 5, comprises
a flexible, semi rigid material or a flexible material with good elastic properties, including but not limited to, rope, cord, leather, plastic, webbing, and/or rubber, or any semi rigid, flexible, or fibrous material.

8. The tightening system in claim 1 comprises
an object or objects to which a leash clips.

9. The tightening system in claim 1 comprises
a collar tightness restrictor.

10. The tightening system in claim 1 comprises
any number (including zero) of release mechanism.

11. The tightening system in claim 1 comprises
any number of (including zero) adjustment mechanisms.

12. The adjustment mechanism in claim 11, comprises
any kind of lock made for elastic cords or rope, which includes but is not limited to, crimp locks, slide to release locks, as well as squeeze to release locks for elastic cord.

13. The main collar body in claim 2 comprises,
one collar body.

14. The main collar body in claim 2 comprises,
two collar bodies in one.

15. The main collar body in claim 2 comprises,
combination of a collar body and/or bodies and components taken from another collar.

16. The main collar body in claim 2, comprises
an object or objects to which a leash clips.

17. The main collar body in claim 2, comprises
a flexible, semi rigid material or a flexible material with poor elastic properties such as but not limited to, chain, rope, cord, leather, plastic, synthetic materials, webbing, rubber, or any flexible or fibrous material.

18. The main collar body in claim 2, comprises
any number (including zero) of release mechanism.

19. The method in claim 3, wherein
a collar is wrapped around an animal's neck.

20. The method in claim 3, wherein
a collar is slipped over an animal's head and placed on the animal's neck.
